(19) United States
(12) Patent Application Publication
(10) Pub. No.: US 2007/0113723 A1
(43) Pub. Date: May 24, 2007

(54) Music content using apparatus, method of controlling the apparatus, and computer-readable medium storing program for implementing the method

(75) Inventor: Shigehiko Mizuno, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-Shi (JP)

(21) Appl. No.: 11/599,718

(22) Filed: Nov. 14, 2006

(30) Foreign Application Priority Data
Nov. 18, 2005 (JP) 2005-334759

(51) Int. Cl. G09B 15/02

(52) U.S. Cl. 84/483.2

(57) ABSTRACT

A music content using apparatus which is capable of offering a low-power, easy-to-see, and easy-on-the-eyes display while protecting music contents by copyright. Music content data provided by a music content providing apparatus is received and temporarily stored in a buffer and supplied to electronic paper. The electronic paper is caused to display the music content data thereon. Immediately after the music content data is displayed on the electronic paper, the music content data is erased from the buffer.

### BACKGROUND OF THE INVENTION

1. Field of the Invention

The present invention relates to a music content using apparatus and a method of controlling the same that provide musical scores, lyrics, etc. for users through the use of music contents including musical score data, lyric data, etc., as well as a computer-readable medium storing a program for implementing the method.

2. Description of the Related Art

As music content using apparatuses that provide musical scores, lyrics, etc. for users through the use of music contents including musical score data, lyric data, etc., there have been known apparatuses which display musical scores, lyrics, or the like on a display according to stored performance information, musical score display information, lyric display information, or the like (see Japanese Laid-Open Patent Publication (Kokai) No. 2002-258838, for example).

There have also been known client apparatuses (music content using apparatuses) which download music contents including musical score data from servers and display musical scores based on the music contents (see Japanese Laid-Open Patent Publication (Kokai) No. 2004-118256, for example).

In the former, however, a display that emits light on its own, such as a liquid crystal display or CRT (Cathode Ray Tube), is used as the display, and hence much power is consumed and eyes get tired at staring at the display.

Also, in the latter, since music contents are used after being downloaded and stored in an internal storage device (e.g. hard disk drive), there is a high possibility that the stored music contents will be maliciously distributed.

### SUMMARY OF THE INVENTION

It is an object of the present invention to provide a music content using apparatus and a method of controlling the same that are capable of offering a low-power, easy-to-see, and easy-on-the-eyes display while protecting music contents by copyright, as well as a computer-readable medium storing a program for implementing the method.

To attain the above object, in a first aspect of the present invention, there is provided a music content using apparatus comprising electronic paper, a receiving device that receives music content data provided by a music content providing apparatus, a buffer that temporarily stores the music content data received by the receiving device, an electronic paper control device that supplies the music content data stored in the buffer to the electronic paper and causes the electronic paper to display the music content data thereon, and an erasing device that erases the music content data from the buffer immediately after the music content data is displayed on the electronic paper by the electronic paper control device.

With the arrangement of the music content using apparatus in the first aspect of the present invention, music content data provided by the music content providing apparatus and temporarily stored in the buffer is supplied to and displayed on the electronic paper, and immediately after that, the music content data is erased from the buffer. Thus, music content data which should be protected by copyright does not remain in the apparatus on a permanent basis. As a result, the leaking of music content data in the form of electronic data from the apparatus can be minimized, and therefore the copyright protection of music content data can be strengthened.

Preferably, the music content using apparatus further comprises a display different from the electronic paper, a display control device that causes the display to display thereon music content data candidates that can be provided by the music content providing apparatus, and a transmitting device that transmits information identifying music content data designated by a user from among the music content data candidates displayed on the display by the display control device to the music content providing apparatus.

More preferably, display data for displaying the music content data candidates is received from the music content providing apparatus via the receiving device.

To attain the above object, in a second aspect of the present invention, there is provided a music content using apparatus comprising electronic paper, a receiving device that receives music content data provided by a music content providing apparatus, a buffer that temporarily stores a plurality of pieces of music content data received by the receiving device, an electronic paper control device that supplies one piece of music content data selected from among the plurality of pieces of music content data stored in the buffer to the electronic paper and causes the electronic paper to display the music content data thereon, and an erasing device that, when new music content data is received by the receiving device in a state in which a predetermined number of pieces of music content data are stored in the buffer, erases any music content data selected from the stored music content data from the buffer so as to store the new music content data, and when expired music content data is stored in the buffer, erases the music content data from the buffer.

With the arrangement of the music content using apparatus in the second aspect of the present invention, a predetermined number or smaller number of pieces of music content data among music content data acquired in the past are stored in the buffer, and hence in using the stored music content data again, it is possible to quickly access the music content data. Thus, the ease of operation for users can be enhanced. Further, since only music content data which has not expired is stored in the buffer, the leaking of music content data in the form of electronic data from the apparatus can be minimized, and therefore the copyright protection of music content data can be further strengthened.

Preferably, the music content using apparatus further comprises a display different from the electronic paper, a display control device that causes the display to display thereon music content data candidates that can be provided by the music content providing apparatus, and a transmitting device that transmits information identifying music content data designated by a user from among the music content data candidates displayed on the display by the display control device to the music content providing apparatus.

More preferably, display data for displaying the music content data candidates is received from the music content providing apparatus via the receiving device.

More preferably, the transmitting device transmits login information for causing the music content using apparatus to log into the music content providing apparatus to the music content providing apparatus, the receiving device receives music content data provided by the music content providing apparatus after the music content providing apparatus having received the login information transmitted by the transmitting device causes the music content using apparatus to log into the music content providing apparatus, the transmitting device transmits logout information for causing the music content using apparatus to log out the music content providing apparatus to the music content providing apparatus, and the erasing device erases all of music content data stored in the buffer when the music content providing apparatus having received the logout information transmitted by the transmitting device causes the music content using apparatus to log out the music content providing apparatus.

To attain the above object, in a third aspect of the present invention, there is provided a method of controlling a music content using apparatus including electronic paper, comprising a receiving step of receiving music content data provided by a music content providing apparatus, a electronic paper control step of supplying the music content data stored in a buffer that temporarily stores the music content data received in the receiving step to the electronic paper and causing the electronic paper to display the music content data thereon, and an erasing step of erasing the music content data from the buffer immediately after the music content data is displayed on the electronic paper in the electronic paper control step.

According to the third aspect of the present invention, the same effects as those obtained by the music content using apparatus according to the first aspect of the present invention can be obtained.

To attain the above object, in a fourth aspect of the present invention, there is provided a method of controlling a music content using apparatus including electronic paper, comprising a receiving step of receiving music content data provided by a music content providing apparatus, an electronic paper control step of supplying one piece of music content data selected from among a plurality of pieces of music content data stored in a buffer that temporarily stores the plurality of pieces of music content data received in the receiving step to the electronic paper and causes the electronic paper to display the music content data thereon, and an erasing step of, when new music content data is received in the receiving step in a state in which a predetermined number of pieces of music content data are stored in the buffer, erasing any music content data selected from the stored music content data from the buffer so as to store the new music content data, and when expired music content data is stored in the buffer, erasing the music content data from the buffer.

According to the fourth aspect of the present invention, the same effects as those obtained by the music content using apparatus according to the second aspect of the present invention can be obtained.

To attain the above object, in a fifth aspect of the present invention, there is provided a computer-readable medium storing a program for causing a computer to execute a method of controlling a music content using apparatus including electronic paper, comprising, a receiving step of receiving music content data provided by a music content providing apparatus, a electronic paper control step of supplying the music content data stored in a buffer that temporarily stores the music content data received in the receiving step to the electronic paper and causing the electronic paper to display the music content data thereon, and an erasing step of erasing the music content data from the buffer immediately after the music content data is displayed on the electronic paper in the electronic paper control step.

According to the fifth aspect of the present invention, the same effects as those obtained by the music content using apparatus according to the first aspect of the present invention can be obtained.

To attain the above object, in a sixth aspect of the present invention, there is provided a computer-readable medium storing a program for causing a computer to execute a method of controlling a music content using apparatus including electronic paper, comprising a receiving step of receiving music content data provided by a music content providing apparatus, an electronic paper control step of supplying one piece of music content data selected from among a plurality of pieces of music content data stored in a buffer that temporarily stores the plurality of pieces of music content data received in the receiving step to the electronic paper and causes the electronic paper to display the music content data thereon, and an erasing step of, when new music content data is received in the receiving step in a state in which a predetermined number of pieces of music content data are stored in the buffer, erasing any music content data selected from the stored music content data from the buffer so as to store the new music content data, and when expired music content data is stored in the buffer, erasing the music content data from the buffer.

According to the sixth aspect of the present invention, the same effects as those obtained by the music content using apparatus according to the second aspect of the present invention can be obtained.

The above and other objects, features, and advantages of the invention will become more apparent from the following detained description taken in conjunction with the accompanying drawings.

### BRIEF DESCRIPTION OF THE DRAWINGS

FIG. 1 is a block diagram schematically showing the construction of a music content using apparatus according to a first embodiment of the present invention;

FIG. 2 is a diagram useful in explaining the principle of operation of electronic paper appearing in FIG. 1;

FIGS. 3A and 3B are flow charts showing the procedures of control processes carried out by the music content using apparatus and a music content providing apparatus (server computer) in FIG. 1;

FIG. 4 is a diagram showing an example of the area configuration of each buffer provided in a RAM of the music content using apparatus in FIG. 1; and

FIGS. 5A and 5B are flow charts showing the procedures of control processes carried out by a music content using apparatus and a music content providing apparatus according to a second embodiment of the present invention.

### DETAILED DESCRIPTION OF THE PREFERRED EMBODIMENTS

The present invention will now be described in detail with reference to the drawing showing preferred embodiments thereof.

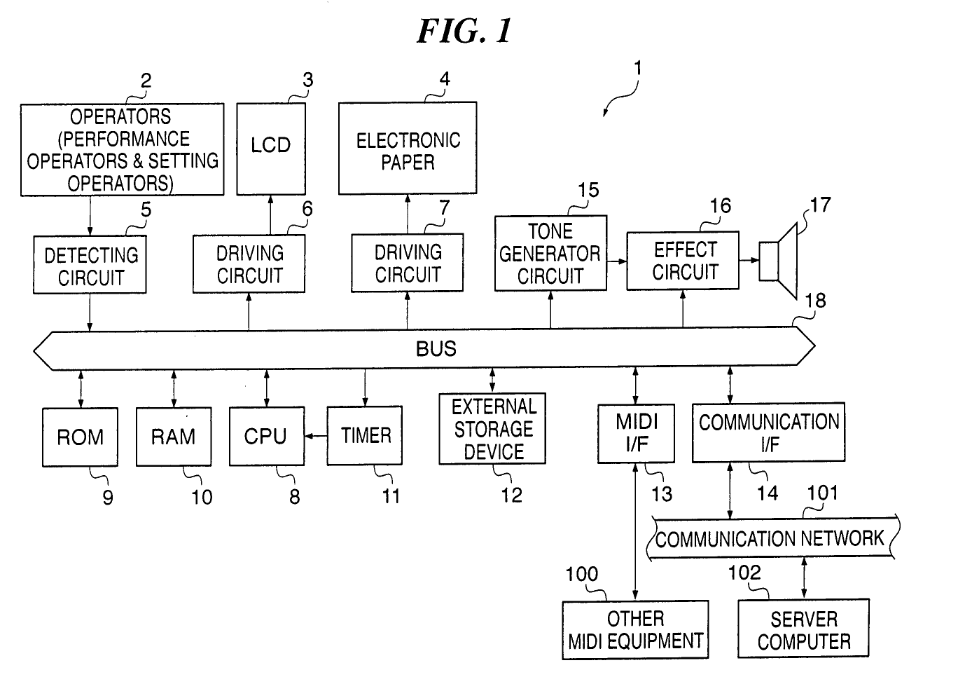

FIG. 1 is a block diagram schematically showing the construction of a music content using apparatus 1 according to a first embodiment of the present invention.

As shown in FIG. 1, the music content using apparatus 1 is comprised of a plurality of operators 2 comprised of performance operators including a keyboard for inputting pitch information and setting operators including a plurality of switches, a keyboard, and a mouse for inputting various kinds of information; a liquid crystal display (LCD) 3 for displaying various setting information and others; electronic paper 4 for displaying music content data; a detecting circuit 5 for detecting operative states of the respective operators 2; a driving circuit 6 for driving the LCD 3; a driving circuit 7 for driving the electronic paper 4; a CPU 8 that controls the entire apparatus; a ROM 9 that stores control programs executed by the CPU 8, various table data, etc.; a RAM 10 for temporarily storing musical composition data, music content data, various input information, computation results, etc.; a timer 11 that measures an interrupt time for timer interrupt processing and various kinds of time; an external storage device 12 that stores various application programs including control programs, various musical composition data, various other data, etc.; a MIDI interface (I/F) 13 that inputs MIDI (Musical Instrument Digital Interface) messages from external devices and outputs MIDI messages to external devices; a communication interface (I/F) 14 that performs transmission and reception of data to and from a server computer (hereinafter simply referred to as “the server”) 102 via a communication network 101; a tone generator circuit 15 that converts performance data input using the operators 2, the stored musical composition data, etc. into audio signals; an effect circuit 16 that applies various effects to audio signals from the tone generator circuit 15; and a sound system 17 that converts audio signals from the effect circuit 16 into sounds and is comprised of a DAC (Digital-to-Analog Converter), an amplifier, a speaker, etc.

The above component elements 5 to 16 are connected to one another via a bus 18. The timer 11 is connected to the CPU 8, other MIDI equipment 100 to the MIDI I/F 13, the communication network 101 to the communication I/F 14, the effect circuit 16 to the tone generator circuit 15, and the sound system 17 to the effect circuit 16.

Here, the communication I/F 14 and the communication network 101 should not necessarily be wired, but may be wireless. Alternatively, one may be wired and the other may be wireless.

The external storage device 12 may be implemented, for example, by a flexible disk drive (FDD), a hard disk drive (HDD), a CD-ROM drive, or a magneto-optical (MO) disk drive. The external storage device 12 may store the control programs executed by the CPU 8 as mentioned above. If one or more of the control programs are not stored in the ROM 9, the control program(s) may be stored in the external storage device 12, and by reading out the control program(s) from the external storage device 12 and storing the same in the RAM 10, the CPU 8 can operate in the same manner as if the control program(s) were stored in the ROM 9. This enables adding control programs and upgrading the version of the control programs with ease.

The MIDI I/F 13 need not be a dedicated one, but may be implemented by a universal interface such as RS-232C, USB (Universal Serial Bus), and IEEE1394. In this case, data other than MIDI message data may be transmitted and received simultaneously via the MIDI I/F 13.

As mentioned above, the communication I/F 14 is connected to the communication network 101 which may be a LAN (Local Area Network), the Internet, a telephone line, or the like, for connection to the server 102 via the communication network 101. When one or more of the above programs and various parameters are not stored in the external storage device 12, the communication I/F 14 is used to download such programs and parameters from the server 102. The music content using apparatus 1 as a client transmits a command or commands for downloading one or more programs and parameters to the server 102 via the communication I/F 14 and the communication network 101. Responsive to this command, the server 102 distributes the requested program(s) and parameters to the music content using apparatus 1 via the communication network 101, and the music content using apparatus 1 receives the program(s) and parameters via the communication I/F 14 and stores them in the external storage device 12, thus completing the download.

As will be understood from the above described construction, the music content using apparatus 1 is constructed on an electronic musical instrument.

In the case where the music content using apparatus 1 is implemented by an electronic musical instrument, the electronic musical instrument should not necessarily be a keyboard musical instrument, but may be a stringed instrument, a wind instrument, a percussion instrument, or the like. Further, a tone generator apparatus, the music content using apparatus 1, and so forth should not necessarily be incorporated into the main body of one electronic musical instrument, but may be configured as separate bodies and connected to each other via some communication means such as a MIDI I/F and various kinds of networks.

Further, the music content using apparatus 1 according to the present embodiment may be constructed on a dedicated apparatus, other than an electronic musical instrument, which is comprised of the minimum elements that can practice the present invention. Examples of the dedicated apparatus include a karaoke machine, a game machine, and a portable communication terminal such as a cellular phone. In the case where a portable communication terminal is used, it should not necessarily be configured such that predetermined functions can be realized by the terminal, but part of the functions may be assigned to a server so that a system comprised of the terminal and the server can realize the whole functions. Alternatively, the music content using apparatus 1 according to the present embodiment may be constructed on a general-purpose personal computer.

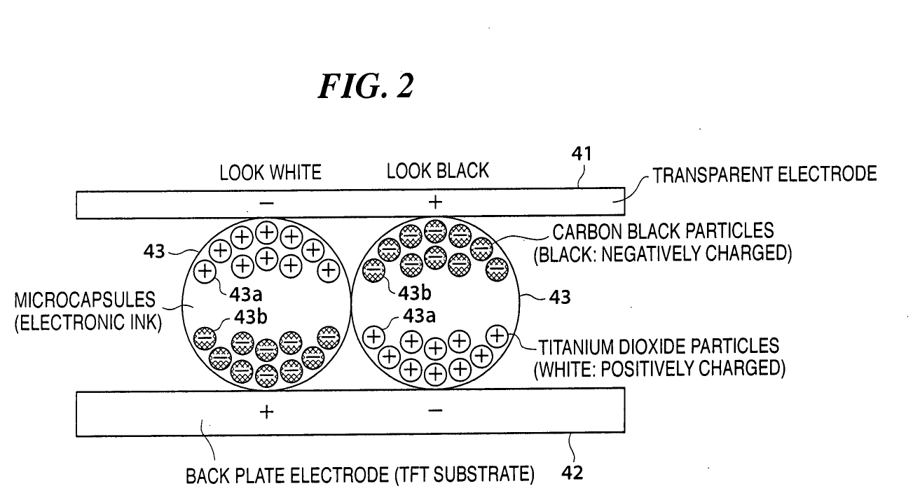

FIG. 2 is a diagram useful in explaining the principle of operation of the electronic paper 4.

As shown in FIG. 2, the electronic paper 4 has a sandwich structure in which many microcapsules (electronic ink) 43 are sandwiched between a sheet-like transparent electrode 41 and a back plate electrode 42 comprised of a sheet-like TFT (Thin Film Transistor) substrate. Each microcapsule 43 is transparent and crammed with many titanium dioxide particles 43a and carbon black particles 43b.

When a voltage is applied between the transparent electrode 41 and the back plate electrode 42, each titanium dioxide particle 43a becomes positively charged and each carbon black particle 43b becomes negatively charged. Thus, when a voltage is applied in such a manner that it negatively charges the transparent electrode 41′s side and positively charges the back plate electrode 42′s side, the positively-charged titanium dioxide particles 43a are drawn toward the transparent electrode 41 and the negatively-charged carbon black particles 43b are drawn toward the back plate electrode 42 through electrophoresis. Namely, since the titanium dioxide particles 43a which are white gather around the transparent electrode 41, the surface of the transparent electrode 41 looks white. On the other hand, when a voltage is applied in such a manner that it positively charges the transparent electrode 41′s side and negatively charges the back plate electrode 42′s, the surface of the transparent electrode 41 looks black. By providing control in this manner to make the surface of the transparent electrode 41 look white and black, characters and drawings are displayed on the electronic paper 4.

There are known some types of electronic paper which employ display principles different from the above described microcapsule electrophoresis. Examples of such alternative display principles include a twisting-ball method, a horizontal migration electrophoresis method, and an electrolytic deposition/dissolution method. The gist of the present invention, however, lies in the apparatus equipped with electronic paper, not in electronic paper itself, and hence description of the alternative display principles is omitted. As a matter of course, it goes without saying that electronic paper which employs display principles different from the microcapsule electrophoresis may be adopted although description of the principles is omitted.

Electronic paper has advantages and disadvantages as listed below irrespective of display principles. The main advantages are as follows:
(1) Easy to see and easy on the eyes since electronic paper is a high-contrast reflective type
(2) Thin, lightweight, and flexible
(3) Power saving is possible since the same display as before power supply is maintained even if the supply of power is stopped.

The main disadvantage is as follows:
(4) It takes a long time (several dozen to several hundred milliseconds) to rewrite display contents due to low reaction rate.

In the present invention, musical scores and lyrics, which are often distributed in the form of paper, are displayed on the electronic paper using the above-mentioned advantage (2) that the electronic paper is close to paper. Further, in the present invention, using the above advantage (3), musical content data is erased from the buffer immediately after being displayed (first embodiment), or when the number of pieces of music content data exceeds a predetermined value or when musical content data expires, the musical content data is erased from the buffer (second embodiment), so that the malicious distribution of musical content data in the form of electronic data is minimized. Since musical content data is not stored in the form of electronic data in the musical content using apparatus 1, the musical content data is regarded as having been streamed, not downloaded, and copyright fees (usage fees for musical content data) may be set to low prices.

Although in the present embodiment, it is assumed that the electronic paper is fixedly set up on the music content using apparatus, the present invention is not limited to this, electronic paper which is detachably mounted on the music content using apparatus via a dedicated interface or a universal interface such as USB, or electronic paper which is physically separate from the musical content using apparatus and selectively displays screen views in accordance with instructions transmitted by wireless from the musical content using apparatus may be adopted. In the case where electronic paper which is fixedly set up on the musical content using apparatus is adopted as in the present embodiment, it is preferred that the electronic paper is placed on a score rest. Also, in the case where electronic paper detachably mounted on the musical content using apparatus is adopted, it is preferred that the electronic paper has such a shape as to be placed on a score rest (for example, the same size and thickness as those of a sheet score). Further, in the case where detachable/attachable electronic paper is adopted, a driving circuit that drives the electronic paper may be fixed to the main body of the music content using apparatus so that only the electronic paper is detachable/attachable, or the driving circuit and the electronic paper may be configured as an integral unit, which is detachable/attachable.

As described above, the music content using apparatus 1 displays musical scores and lyrics as music contents on the electronic paper 4. Music content data for use in display are those provided by the server 102 in response to a request given to the server 102. Specifically, the server 102 has a function of providing music content data as well as the function of providing control programs executed by the CPU 8 as described above. In the present invention, since the function of providing music content data is more important than the function of providing control programs, and therefore the server 102 will hereafter be referred to as “the music content providing apparatus 102.” Since the music content providing apparatus 102 has only to have functions which ordinary servers have, the music content providing apparatus 102 may be comprised of the component elements of the music content using apparatus 1 except the performance-associated component elements (i.e. performance operators, tone generator circuit, effect circuit, etc.), the electronic paper-associated component elements (i.e. the main body of the electronic paper and the driving circuit that drives the electronic paper), and the MIDI-associated component elements (i.e. MIDI I/F and MIDI equipment).

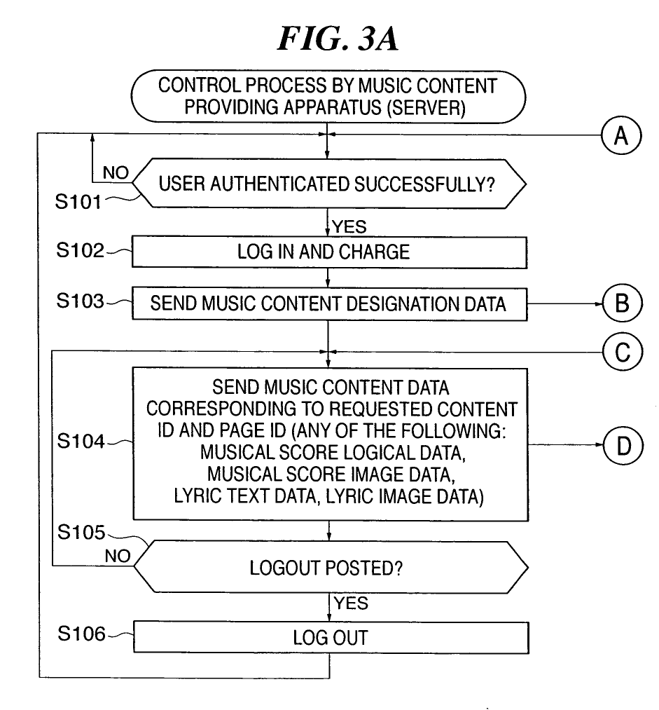

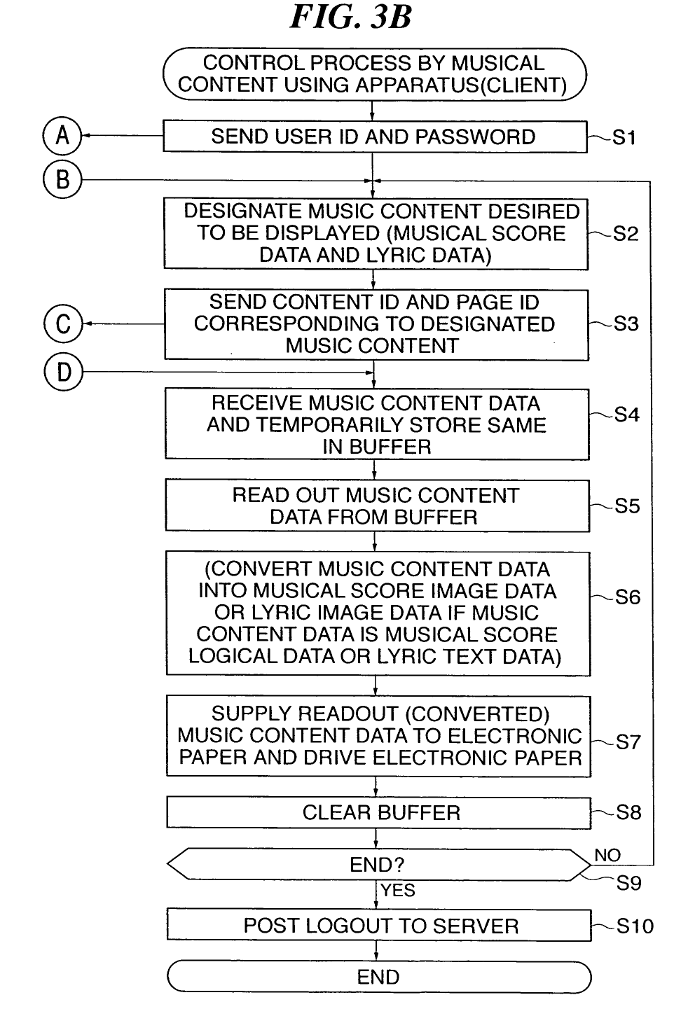

Referring to FIGS. 3A and 3B, a detailed description will now be given of control processes carried out by the music content using apparatus 1 and the music content providing apparatus 102 constructed as described above.

FIGS. 3A and 3B are flow charts showing the procedures of the control processes carried out by the music content using apparatus 1 and the music content providing apparatus 102.

As shown in FIGS. 3A and 3B, the music content using apparatus 1 and the music content providing apparatus 102 carry out the control processes in cooperation with each other.

The music content using apparatus 1 mainly carries out:
(a) Login requesting process (step S1)
(b) Music content designating process (steps S2 and S3)
(c) Music content displaying process (steps S4 to S8)
(d) Logout requesting process (step S10).

On the other hand, the music content providing apparatus 102 mainly carries out:
(A) Login process (step S102)
(B) Music content designation data providing process (step S103)
(C) Music content data providing process (step S104)
(D) Logout process (step S105).

First, when the control process by the music content using apparatus 1 is started, a user authentication screen for entering information required to log into the music content providing apparatus 102 (in the present embodiment, user ID and password) is displayed on the LCD 3. When the user types his/her user ID and password in a user ID entry field and a password entry field, respectively, of the user authentication screen, the music content using apparatus 1 goes to the login requesting process (a). In the login requesting process (a), the entered user ID and password are transmitted to the music content providing apparatus 102 via the communication I/F 14.

The music content providing apparatus 102 performs user authentication based on the user ID and the password transmitted from the music content using apparatus 1 (step S101). If the user is successfully authenticated in the step S101, the music content providing apparatus 102 goes to the login process (A). In the login process (A), the music content providing apparatus 102 causes the music content using apparatus 1 to log into the music content providing apparatus 102 and charges (the user of) the music content using apparatus 1. In the present embodiment, the music content providing apparatus 102 charges on a flat monthly rate. Thus, the user is charged only at the first login of each month and not charged till the end of the month even if he/she logs into the musical content providing apparatus 102 again and again. It is to be understood, however, that the present invention is not limited to this; the music content providing apparatus 102 may charge for each page of music contents, i.e. on an as-used basis, or may set in advance the maximum number of times musical contents can be downloaded and charges for each page of music contents when downloading of musical contents a greater number of times than the set maximum number of times is instructed, i.e. on a quasi-flat monthly rate. Also, the music content providing apparatus 102 should not necessarily charge on a monthly rate, but may charge on a day basis or yearly basis. Further, another method of charging may be adopted in which, when a user enters his/her credit card number in response to an inquiry about his/her credit card number, a usage fee for provided music contents is charged to a credit-card company. As a matter of course, the method of charging is not limited to the above described ones, but any other methods may be adopted.

Upon completing the login process (A), the music content providing apparatus 102 goes to the music content designation data providing process (B). In the music content designation data providing process (B), display data (music content designation page data) to be displayed on the LCD 3 is transmitted to the music content using apparatus 1 so as to designate a music content desired to be provided by the music content providing apparatus 102. Upon receiving the music content designation page data via the communication I/F 14, the music content using apparatus 1 goes to the music content designating process (b).

In the music content designating process (b), first, the received music content designation page data is displayed on the LCD 3. The music content designation page data includes a plurality of pieces of data of one display screen comprised of a plurality of pieces of information identifying a music content (such as a content ID). Thus, one of a plurality of music content designation pages is displayed on the LCD 3, and hence, at the same time, tabs for selectively displaying other pages are also displayed on the LCD 3. It should be noted that a content ID is ordinarily represented by a numeric value, a content ID is hard for a user to grasp when the content ID is displayed as it is. For this reason, it is preferred that information indicative of a music content title is displayed in association with a content ID.

Next, when the user designates a music content desired to be provided (displayed) from the music content designation page displayed on the LCD 3, a content ID and a page ID corresponding to the designated music content are temporarily stored in the RAM 10. The music content using apparatus 1 then transmits the content ID and the page ID to the music content providing apparatus 102 via the communication I/F 14.

Upon receiving the content ID and the page ID from the music content using apparatus 1, the music content providing apparatus 102 goes to the music content data providing process (C). In the music content data providing process (C), the music content providing apparatus 102 retrieves music content data corresponding to the received content ID and page ID from an internal HDD, not shown, and transmits the retrieved music content data to the music content using apparatus 1. Music content data is data for displaying a musical score or lyrics. Examples of data for displaying musical scores include musical score logical data and musical score image data, and examples of data for displaying lyrics include lyric text data and lyric image data.

Musical score logical data is data including information required to display various elements (notes, rests, and other musical symbols) constituting a musical score, i.e. information indicative of the types of the respective elements and positional information indicative of positions at which the respective elements are displayed. Thus, musical score logical data cannot be displayed as it is and has to be displayed after being converted into musical score image data. However, the data capacity of musical score logical data is smaller than that of musical score image data, and hence musical score logical data has the advantage that many pieces of musical score logical data can be stored in the internal HDD.

Musical score image data is display data that can be displayed as it is, and bitmap data is widely known. As a matter of course, not only bitmap data but data in any form may be used insofar as they can be displayed without being converted into data in other forms.

Lyric text data is data comprised of character codes which represent lyrics. As is the case with musical score logical data, lyric text data cannot be displayed as it is and has to be displayed after converted into lyric image data. Lyric text data, however, also has the advantage of having a smaller data capacity as compared with lyric image data.

As is the case with musical score image data, lyric image data is display data which can be displayed as it is.

In the present embodiment, musical score logical data or musical score image data associated with one musical score is stored in the HDD, and lyric text data or lyric image data associated with lyrics of one song is stored in the HDD. That is, musical score logical data, musical score image data, lyric text data, and lyric image data are mixed in the HDD.

It should be noted that music content data should not necessarily be data for displaying a musical score or lyrics but may be data for displaying both a musical score and lyrics. Examples of methods to manage music content data include a method in which musical score data (musical score logical data or musical score image data) and lyric data (lyric text data or lyric image data) are collectively managed, and a method in which musical score data and lyric data are managed independently of each other. In the former, the music content providing apparatus 102 may retrieve music content data designated by the user of the music content using apparatus 1 and transmit the retrieved data directly to the music content using apparatus 1 irrespective of whether the designated music content data is data for displaying only a musical score, data for displaying only lyrics, or data for displaying both a musical score and lyrics. On the other hand, in the latter, the music content providing apparatus 102 may retrieve music content data designated by the user of the music content using apparatus 1 and transmit the retrieved data directly to the music content using apparatus 1 as in the former, when the designated music content data is data for displaying only a musical score or data for displaying only lyrics, but when music content data designated by the user of the music content using apparatus 1 is data for displaying both a musical score and lyrics, the music content providing apparatus 102 has to retrieve two kinds of data consisting of corresponding musical score data and lyric data and transmit the two kinds of data together to the music content using apparatus 1. The latter is adopted in the present embodiment, but this is only for the convenience of explanation, and as a matter of course, the former may be adopted.

Further, in the present embodiment, it is assumed that music content data is data for displaying either of a musical score and lyrics, not data for displaying a musical score and lyrics together. This is because control processing performed on music content data for displaying a musical score and lyrics together can be easily inferred by analogy from control processing performed on music content data for displaying either of a musical score and lyrics.

Next, upon receiving the music content data transmitted from the music content providing apparatus 102 via the communication I/F 14, the music content using apparatus 1 goes to the music content displaying process (c). In the music content displaying process (c), first, the received music content data is temporarily stored in a buffer reserved at a predetermined location in the RAM 10. Next, the temporarily-stored music content data is read out from the buffer. If the read music content data is data which requires conversion (musical score logical data or lyric text data), the read music content data is converted into display data (musical score image data or lyric image data), and the resulting music content data is supplied to the electronic paper 4. The method to convert musical score logical data or lyric text data into musical score image data or lyric image data is not a feature of the present invention, and hence a known method can be used.

On the other hand, if the read music content data is data which does not require conversion (musical score image data or lyric image data), the read music content data is directly supplied to the electronic paper 4.

When the supply of the music content data to the electronic paper 4 is completed, the driving circuit 7 drives the electronic paper 4. As a consequence, the supplied music content data is displayed on the electronic paper 4. Immediately after that, the buffer is cleared.

As described above, once the electronic paper 4 has displayed a certain screen, it keeps this screen displayed except where the screen is rewritten into another screen. Specifically, even if display data is not continuously supplied from the buffer to the electronic paper 4, the electronic paper 4 keeps the present screen displayed, and therefore, music content data temporarily stored in the buffer can be erased immediately after being supplied to the electronic paper 4. Thus, music content data which has to be protected by copyright does not remain in the buffer, i.e. the music content using apparatus 1, and hence the leaking of music content data in the form of electronic data from the apparatus can be minimized. As a consequence, the copyright protection of music content data can be strengthened.

The music content using apparatus 1 repeatedly carries out the music content designating process (b) and the music content displaying process (c) described above until the user instructs termination of the process (step S9). When the user instructs termination of the process, the music content using apparatus 1 goes to the logout requesting process (d). In the logout requesting process (d), the logout is posted to the music content providing apparatus 102 via the communication I/F 14.

The music content providing apparatus 102 constantly checks whether or not the logout has been posted by the music content using apparatus 1 (step S105) and repeatedly carries out the music content data providing process (C) until the logout is posted from the music content using apparatus 1 to the music content providing apparatus 102. When the logout is posted from the music content using apparatus 1 to the music content providing apparatus 102, the music content providing apparatus 102 goes to the logout process (D). In the logout process (D), the music content using apparatus 1 is caused to log out the music content providing apparatus 102. The music content providing apparatus 102 then returns to the step S101 in which it determines whether or not the user has been successfully authenticated.

Next, a description will be given of a music content using apparatus according to a second embodiment of the present invention.

The music content using apparatus according to the second embodiment differs only in part of control processing from the music content using apparatus according to the first embodiment described above and therefore employs the same hardware as that of the music content using apparatus according to the first embodiment, i.e. the hardware illustrated in FIG. 1.

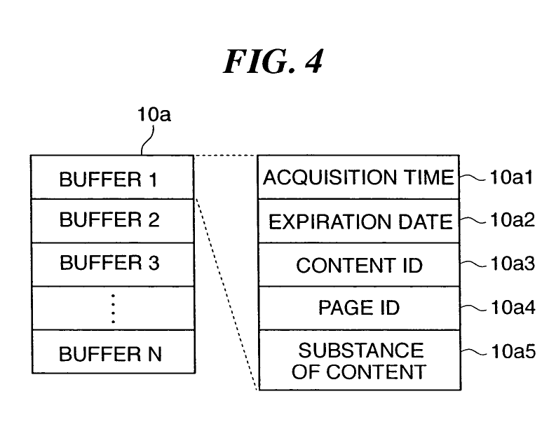

As described above, the music content using apparatus according to the first embodiment has the buffer in which only one piece of music content data is temporarily stored, reads out temporarily-stored music content data from the buffer (converts the music content data after reading out the same), and erases the music content data immediately after supplying the same to the electronic paper 4. On the other hand, as shown in FIG. 4, the content using apparatus according to the present embodiment has a plurality of (N) buffers 10a in the RAM 10, in which a plurality of (N) pieces of music content data corresponding in number to the maximum number of (N) buffers 10a can be stored until the music content data expires (for example, until 72 hours elapse) after being stored. In displaying again music content data which has already been provided by the music content providing apparatus 102, music content data stored in the buffer 10a is read out to be quickly displayed again without the need to receive the musical content data again from the music content providing apparatus 102.

FIG. 4 is a diagram showing an example of the area configuration of each buffer 10a provided in the RAM 10 of the music content using apparatus according to the present embodiment.

As shown in FIG. 4, each buffer 10a is comprised of an area 10a1 in which acquisition time data indicative of the time at which music content data was acquired from the music content providing apparatus 102 is stored, an area 10a2 in which expiration date data indicative of the expiration date of the music content data is stored, an area 10a3 and an area 10a4 in which ID data and page ID data indicative of a content ID and a page ID, respectively, identifying the music content data are stored, and an area 10a5 in which the music content data itself (i.e. the substance of the music content data) is stored.

Acquisition time data is indicative of the time at which music content data provided by the music content providing apparatus 102 was stored in any of the buffers 10a. The music content using apparatus according to the present embodiment has an ordinary clock function since it is equipped with the timer 11. The acquisition time can be obtained using the clock function, but if the music content using apparatus does not have the clock function, the transmission time (substantially the same time as the acquisition time) is obtained when the music content providing apparatus 102 transmits music content data to generate transmission time data, which is in turn transmitted together with the music content data.

Expiration date data is stored in association with music content data in the case where expiration date varies according to music content data. Thus, when the expiation dates of all the pieces of music content data are the same, it is unnecessary to store expiration date data with respect to each piece of music content data. It should be noted that expiration date data transmitted from the music content providing apparatus 102 can be stored as it is.

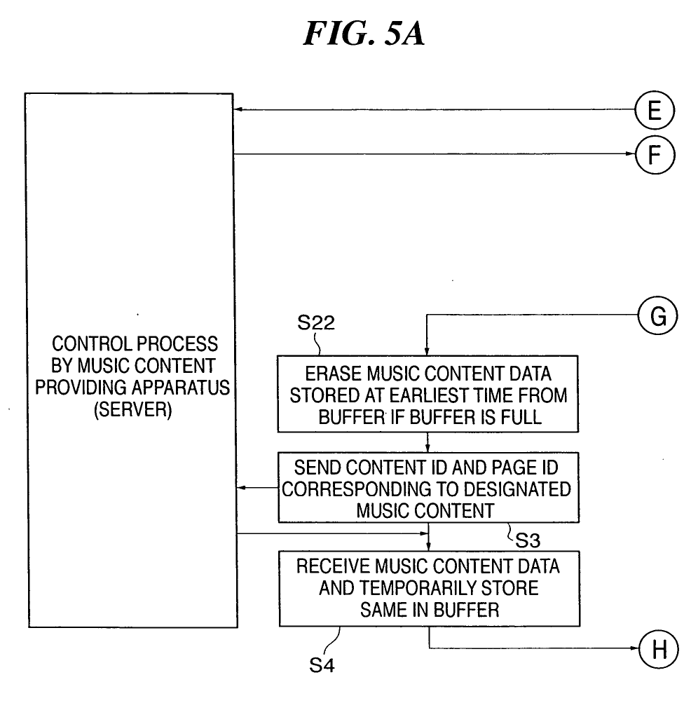

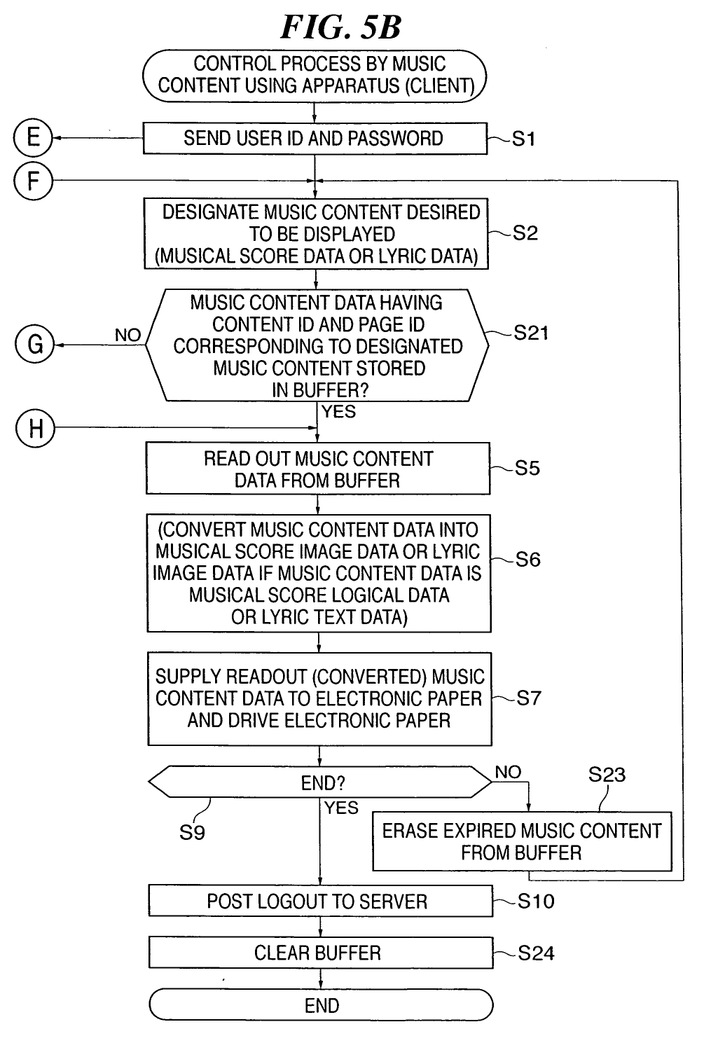

FIGS. 5A and 5B are flow charts showing the procedures of control processes carried out by the music content using apparatus and the music content providing apparatus according to the present embodiment. As shown in FIGS. 5A and 5B, the control process carried out by the music content providing apparatus is identical with the process of FIGS. 3A and 3B carried out by the music content providing apparatus according to the first embodiment described above, and therefore, only a box is illustrated in FIGS. 5A and 5B without concretely describing the control process carried out by the music content providing apparatus. In FIGS. 5A and 5B, steps in which the same processing is performed as in the corresponding steps in FIGS. 3A and 3B are designated by the same step numbers, and description thereof is omitted.

When the user designates a music content desired to be displayed in a step S2, first, it is determined whether or not music content data with a content ID and a page ID corresponding to the designated music content is stored in any of the plurality of buffers 10a (step S21). Since each buffer 10a has the areas 10a3 and the 10a4 in which contents IDs and page IDs, respectively, are stored as described above, whether or not the designated music content is stored in any of the buffers 10a can be determined with ease by comparing data stored in the areas 10a3 and 10a4 with the content ID and the page ID corresponding to the designated music content.

If it is determined in the step S21 that the designated music content data is not stored in any of the buffers 10a, it is then determined whether or not there is any free buffer 10a for storing new music content data among the plurality of buffers 10a. If it is determined that there is no free buffer 10a, the contents of a buffer in which music content data stored at the earliest time among music content data stored in the buffers 10 is stored are erased (step S22), and the designated music content data is downloaded from the music content providing apparatus 102 and stored in the buffer (steps S3 and S4). On the other hand, if there is any free buffer among the plurality of buffers 10a, the designated music content data is downloaded from the music content providing apparatus 102 and stored in the buffer (one buffer is selected if there are a plurality of free buffers) (steps S3 and S4).

On the other hand, if it is determined in the step S21 that the designated music content data is stored in any of the buffers 10a, the music content data stored in the area 10a5 of the buffer 10a is read out, and a music content is displayed on the electronic paper 4 based on the read music content data (steps S5 to S7).

After that, in carrying out the music content designating process (b) and the music content displaying process (c) again (the steps S2, S21, S5, S6, S7, and S9), the contents of buffers in which expired music content data is stored among the plurality of buffers 10a is erased. Here, whether or not music content data has expired can be determined with ease by comparing the acquisition time represented by acquisition time data mentioned above and the elapsed time measured by the timer 11 with the expiration date represented by expiration date data.

On the other hand, in terminating the music content designating process (b) and the music content displaying process (c), the logout is posted to the music content providing apparatus 102 (step S10), and all the contents stored in the plurality of buffers 10a are cleared (step S24).

As described above, in the present embodiment, since a predetermined number or smaller number of pieces of music content data among music content data acquired in the past are stored in the buffers 10a, it is possible to quickly access stored music content data when using the music content data, and therefore the ease of operation for users can be enhanced. Further, since only music content data that has not expired is stored in the buffers 10a, the leaking of music content data in the form of electronic data from the apparatus can be minimized, and therefore the copyright protection of music content data can be strengthened.

Although in the above described embodiments, music content data provided by the music content providing apparatus 102 is displayed only on the electronic paper 4 and other information is displayed on the LCD 3, the present invention is not limited to this, but the same music content data may be displayed on both the electronic paper 4 and the LCD 3. In this case, for example, music content data of one page may be displayed on the electronic paper 4, and only part of the music content data (for example, near the currently-played position of a musical composition) may be displayed on the LCD 3.

Further, although in the above described embodiments, music content data is data for displaying musical scores or lyrics, this is because the fact that musical scores and lyrics printed on paper are widely distributed as described above matches up to the feature that electronic paper is close to paper. To put it the other way around, not only musical scores and lyrics but any kinds of objects can be displayed insofar as they can match up to the features of electronic paper.

It is to be understood that the object of the present invention may also be accomplished by supplying a system or an apparatus with a storage medium in which a program code of software, which realizes the functions of any of the above described embodiments is stored, and causing a computer (or CPU or MPU) of the system or apparatus to read out and execute the program code stored in the storage medium.

In this case, the program code itself read from the storage medium realizes the functions of any of the above described embodiments, and hence the program code and a storage medium on which the program code is stored constitute the present invention.

Examples of the storage medium for supplying the program code include a floppy (registered trademark) disk, a hard disk, a magneto-optical disk, a CD-ROM, a CD-R, a CD-RW, a DVD-ROM, a DVD-RAM, a DVD-RW, a DVD+RW, a magnetic tape, a nonvolatile memory card, and a ROM. Alternatively, the program code may be downloaded from a server computer via a communication network.

Further, it is to be understood that the functions of any of the above described embodiments may be accomplished not only by executing a program code read out by a computer, but also by causing an OS (operating system) or the like which operates on the computer to perform a part or all of the actual operations based on instructions of the program code.

Further, it is to be understood that the functions of any of the above described embodiments may be accomplished by writing a program code read out from the storage medium into a memory provided in an expansion board inserted into a computer or a memory provided in an expansion unit connected to the computer and then causing a CPU or the like provided in the expansion board or the expansion unit to perform a part or all of the actual operations based on instructions of the program code.

What is claimed is:

1. A music content using apparatus comprising:
electronic paper;
a receiving device that receives music content data provided by a music content providing apparatus;
a buffer that temporarily stores the music content data received by said receiving device;
an electronic paper control device that supplies the music content data stored in said buffer to said electronic paper and causes said electronic paper to display the music content data thereon; and
an erasing device that erases the music content data from said buffer immediately after the music content data is displayed on said electronic paper by said electronic paper control device.

2. A music content using apparatus according to claim 1, further comprising:
a display different from said electronic paper;
a display control device that causes said display to display thereon music content data candidates that can be provided by the music content providing apparatus; and
a transmitting device that transmits information identifying music content data designated by a user from among the music content data candidates displayed on said display by said display control device to the music content providing apparatus.

3. A music content using apparatus according to claim 2, wherein display data for displaying the music content data candidates is received from the music content providing apparatus via said receiving device.

4. A music content using apparatus comprising:
electronic paper;
a receiving device that receives music content data provided by a music content providing apparatus;
a buffer that temporarily stores a plurality of pieces of music content data received by said receiving device;
an electronic paper control device that supplies one piece of music content data selected from among the plurality of pieces of music content data stored in said buffer to said electronic paper and causes said electronic paper to display the music content data thereon; and
an erasing device that, when new music content data is received by said receiving device in a state in which a predetermined number of pieces of music content data are stored in said buffer, erases any music content data selected from the stored music content data from said buffer so as to store the new music content data, and when expired music content data is stored in said buffer, erases the music content data from said buffer.

5. A music content using apparatus according to claim 4, further comprising:
a display different from said electronic paper;
a display control device that causes said display to display thereon music content data candidates that can be provided by the music content providing apparatus; and
a transmitting device that transmits information identifying music content data designated by a user from among the music content data candidates displayed on said display by said display control device to the music content providing apparatus.

6. A music content using apparatus according to claim 5, wherein display data for displaying the music content data candidates is received from the music content providing apparatus via said receiving device.

7. A music content using apparatus according to claim 4, wherein said transmitting device transmits login information for causing the music content using apparatus to log into the music content providing apparatus to the music content providing apparatus, said receiving device receives music content data provided by the music content providing apparatus after the music content providing apparatus having received the login information transmitted by said transmitting device causes the music content using apparatus to log into the music content providing apparatus, said transmitting device transmits logout information for causing the music content using apparatus to log out the music content providing apparatus to the music content providing apparatus, and said erasing device erases all of music content data stored in said buffer when the music content providing apparatus having received the logout information transmitted by said transmitting device causes the music content using apparatus to log out the music content providing apparatus.

8. A method of controlling a music content using apparatus including electronic paper, comprising:
a receiving step of receiving music content data provided by a music content providing apparatus;
a electronic paper control step of supplying the music content data stored in a buffer that temporarily stores the music content data received in said receiving step to the electronic paper and causing the electronic paper to display the music content data thereon; and
an erasing step of erasing the music content data from the buffer immediately after the music content data is displayed on the electronic paper in said electronic paper control step.

9. A method of controlling a music content using apparatus including electronic paper, comprising:
a receiving step of receiving music content data provided by a music content providing apparatus;
an electronic paper control step of supplying one piece of music content data selected from among a plurality of pieces of music content data stored in a buffer that temporarily stores the plurality of pieces of music content data received in said receiving step to the electronic paper and causes the electronic paper to display the music content data thereon; and
an erasing step of, when new music content data is received in said receiving step in a state in which a predetermined number of pieces of music content data are stored in the buffer, erasing any music content data selected from the stored music content data from the buffer so as to store the new music content data, and when expired music content data is stored in the buffer, erasing the music content data from the buffer.

10. A computer-readable medium storing a program for causing a computer to execute a method of controlling a music content using apparatus including electronic paper, comprising:
a receiving step of receiving music content data provided by a music content providing apparatus;
a electronic paper control step of supplying the music content data stored in a buffer that temporarily stores the music content data received in said receiving step to the electronic paper and causing the electronic paper to display the music content data thereon; and
an erasing step of erasing the music content data from the buffer immediately after the music content data is displayed on the electronic paper in said electronic paper control step.

11. A computer-readable medium storing a program for causing a computer to execute a method of controlling a music content using apparatus including electronic paper, comprising:
a receiving step of receiving music content data provided by a music content providing apparatus;
an electronic paper control step of supplying one piece of music content data selected from among a plurality of pieces of music content data stored in a buffer that temporarily stores the plurality of pieces of music content data received in said receiving step to the electronic paper and causes the electronic paper to display the music content data thereon; and
an erasing step of, when new music content data is received in said receiving step in a state in which a predetermined number of pieces of music content data are stored in the buffer, erasing any music content data selected from the stored music content data from the buffer so as to store the new music content data, and when expired music content data is stored in the buffer, erasing the music content data from the buffer.
